(19) United States
(12) Patent Application Publication
(10) Pub. No.: US 2026/0290800 A1
(43) Pub. Date: Sep. 24, 2026

(54) CATHODE ACTIVE MATERIALS, PREPARING METHOD THEREOF, CATHODE AND ELECTROCHEMICAL DEVICES

(71) Applicant: Research & Business Foundation SUNGKYUNKWAN UNIVERSITY, Suwon-si (KR)

(72) Inventors: Jong Soon KIM, Seoul (KR); Hyung Sub KIM, Sejong-si (KR); Jin Ho AHN, Suwon-si (KR); Jae Il LEE, Daejeon (KR)

(21) Appl. No.: 19/261,040

(22) Filed: Jul. 7, 2025

(30) Foreign Application Priority Data
Mar. 21, 2025 (KR) 10-2025-0036665

(51) Int. Cl. H01M 4/505; H01M 10/0525

(52) U.S. Cl. CPC H01M 4/505; H01M 10/0525

(57) ABSTRACT

Disclosed is a cathode active material for improving the performance of an electrochemical device. According to an aspect of the present disclosure, there is provided a cathode active material including an overlithiated layered oxide (OLO), wherein R calculated in Equation 1 below is 27 or less.

$$R = ( {P}_{A} / {P}_{B} ) \qquad [ Equation l ]$$

In accordance with Small-Angle X-ray Scattering (SAXS): in Equation 1 above, P_{A} is the volume (cm³/g) of macro pores included in the cathode active material, and P_{B} is the volume (cm³/g) of micro pores included in the cathode active material, wherein the macro pores represent the highest volume fraction (cm³g⁻¹/Å) in a radius of 10^{2.5} Å to 10^{3.5} Å, and the micro pores represent the highest volume fraction in a radius of 10¹ Å to 10^{2.5} Å.

### CROSS-REFERENCE TO RELATED APPLICATION

This application claims priority to Korean Patent Application No. 10-2025-0036665 filed on Mar. 21, 2025 and all the benefits accruing therefrom under 35 U.S.C. § 119, the contents of which are incorporated by reference in their entirety.

### BACKGROUND

The present disclosure relates to a cathode active material, and more specifically, to a cathode active material, a manufacturing method thereof, a cathode, and an electrochemical device.

As technology development and demand for mobile devices have increased, the demand for secondary batteries as an energy source has been rapidly increased. Among such secondary batteries, lithium secondary batteries having high energy density and voltage, long cycle life, and low self-discharging rate have been commercialized and widely used.

Lithium transition metal composite oxides are used as cathode active materials of the lithium secondary batteries. Among the lithium transition metal composite oxides, lithium cobalt composite metal oxides such as LiCoO₂, which have a high operating voltage and excellent capacity properties, have been mainly used. However, LiCoO₂ is very poor in thermal properties due to the destabilization of a crystal structure resulting from de-intercalation of lithium ions, and is expensive, and thus, has limitations in mass use as a power source in the field of electric vehicles and the like.

In order to resolve this issue, an overlithiated layered oxide (OLO) has been proposed, but oxidation/reduction reaction of oxygen produces oxidized oxygen species (Oⁿ⁻) in a cathode structure and causes instability, resulting in continuous structure deterioration during a charge/discharge process. In addition, non-reversibility due to oxygen gas release or the like has a problem of critically affecting battery performance.

### CITATION LIST

### Patent Literature

Korean Patent Laid-Open Publication 10-2023-0051828 A (Published on Apr. 19, 2023)

### SUMMARY

According to an aspect of the present disclosure, there is provided a cathode active material for improving the performance of an electrochemical device.

According to another aspect of the present disclosure, there is provided a cathode active material for improving non-reversibility during a charge/discharge process caused by instability of oxidized oxygen.

According to another aspect of the present disclosure, there is provided a cathode active material in which primary particles and secondary particles grow evenly, have excellent particle shape uniformity, and have improved structural stability.

According to another aspect of the present invention, there is provided a cathode active material capable of increasing a moving speed of lithium ions and increasing a charge/discharge rate of an electrochemical device.

According to another aspect of the present invention, there is provided a cathode including the cathode active material.

According to another aspect of the present invention, there is provided an electrochemical device having high charge capacity, discharge capacity, and coulombic efficiency.

The purposes of the present invention are not limited to the purposes mentioned above, and other purposes and advantages of the present invention not mentioned can be understood by the following description, and will be more clearly understood by embodiments of the present invention. In addition, it can be easily seen that the purposes and advantages of the present invention may be implemented by means and combinations thereof described herein.

According to an aspect of the present disclosure, there is provided a cathode active material including an overlithiated layered oxide (OLO), wherein R calculated in Equation 1 below is 27 or less.

$$R = ( {P}_{A} / {P}_{B} ) \qquad [ Equation l ]$$

In accordance with Small-Angle X-ray Scattering (SAXS): in Equation 1 above, P_{A} is the volume (cm³/g) of macro pores included in the cathode active material, and P_{B} is the volume (cm³/g) of micro pores included in the cathode active material, wherein the macro pores represent the highest volume fraction (cm³g⁻¹/Å) in a radius of 10^{2.5} Å to 10^{3.5} Å, and the micro pores represent the highest volume fraction in a radius of 10¹ Å to 10^{2.5} Å.

Preferably, the cathode active material may include a compound represented by General Formula 1 below.

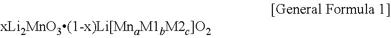

In General Formula 1 above, 0<x<1 and a+b+c=1, wherein 0<a<1, 0≤b<1, and 0≤c<1, and M1 and M2 are transition metals different from each other, which is Ni or Co.

Preferably, the cathode active material may include a compound represented by General Formula 2 below.

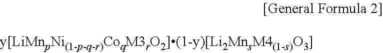

In General Formula 2 above: M3 and M4 are each independently one or more selected from the group consisting of Zr, Al, Re, V, Cr, Fe, Ga, Si, B, Ru, Ti, Nb, Mo, Mg, W, Na, and Pt, and 0.500<y<0.800, 0.450<p<0.650, 0≤q≤0.025, 0≤r≤0.100, and 0.900≤s≤1.000.

Preferably, in accordance with X-ray diffraction (XRD) analysis: There may be provided a cathode active material in which a ratio I₍₀₀₃₎/I₍₁₀₄₎ of a diffraction X-ray intensity I₍₀₀₃₎ at a (003) peak to a diffraction X-ray intensity I₍₁₀₄₎ at a (104) peak is 1.31 or greater.

Preferably, in accordance with Small-Angle X-ray Scattering (SAXS): the macro pores may have a volume of 0.35 cm³/g to 0.45 cm³/g.

Preferably, in accordance with Small-Angle X-ray Scattering (SAXS): the micro pores may have a volume of 0.017 cm³/g to 0.025 cm³/g.

Preferably, in accordance with Small-Angle X-ray Scattering (SAXS): the pores included in the cathode active material may have a total pore volume of 0.475 cm³/g or less.

According another aspect of the present disclosure, there is provided a method for manufacturing a cathode active material, the method including S1 preparing a mixture including an overlithiated layered oxide precursor and a lithium precursor, and S2 heat-treating the mixture to manufacture a cathode active material, wherein in a manufacturing reaction of the cathode active material, the lithium precursor has a molar content lower than a stoichiometric molar content.

Preferably, the molar content of the lithium precursor may be lower than the stoichiometric molar content by 0.5 mol % to 3 mol %.

Preferably, the step S2 may include heat-treating the mixture at 800° C. to 1100° C. for 0.5 hours to 15 hours under an atmospheric atmosphere.

According to another aspect of the present disclosure, there is provided a cathode active material manufactured by the manufacturing method of a cathode active material.

According to another aspect of the present disclosure, there is provided a cathode including a cathode active material of some embodiments.

According to another aspect of the present disclosure, there is provided an electrochemical device including a cathode, an anode, a separator, and an electrolyte.

The above means for achieving the purposes do not include all the features of the present disclosure, and may be combined with some embodiments of the present specification. Various features of the present invention and advantages and effects in accordance thereto may be understood in more detail with reference to the following specific description.

### BRIEF DESCRIPTION OF THE DRAWINGS

Exemplary embodiments can be understood in more detail from the following description taken in conjunction with the accompanying drawings, in which:

FIG. 1A shows Scanning Electron Microscopy-Energy Dispersive X-ray Spectroscopy (SEM-EDS) analysis results of Ni_{0.25}Mn_{0.75}CO₃ according to Manufacturing Preparation Example;

FIG. 1B shows X-ray diffraction (XRD) analysis results of Ni_{0.25}Mn_{0.75}CO₃ of Manufacturing Preparation Example;

FIG. 2 shows XRD analysis results of cathode active materials according to Comparative Examples 1 and 2, and Example;

FIG. 3A shows XRD analysis results of the cathode active material according to Comparative Example 1;

FIG. 3B shows XRD analysis results of the cathode active material according to Comparative Example 2;

FIG. 3C shows XRD analysis results of the cathode active material according to Example;

FIG. 4A is a scanning electron microscope (SEM) photograph of the cathode active material according to Comparative Example 1; FIG. 4B is an enlarged SEM photograph of FIG. 4A;

FIG. 5A is an SEM photograph of the cathode active material according to Comparative Example 2; FIG. 5B is an enlarged SEM photograph of FIG. 5A;

FIG. 6A is an SEM photograph of the cathode active material according to Example; FIG. 6B is an enlarged SEM photograph of FIG. 6A;

FIG. 7A shows transmission electron microscope (TEM) photographs of cross-sections of the cathode active materials according to Comparative Examples 1 and 2 and Example;

FIG. 7B shows TEM photographs showing atomic arrangement analysis of the cathode active materials according to Comparative Examples 1, 2, and Example;

FIG. 8 shows electron energy loss spectroscopy results for the cathode active materials according to Comparative Example 2 and Example;

FIG. 9A shows Small-Angle X-ray Scattering (SAXS) analysis results of the cathode active materials according to Comparative Examples 1 and 2, and Example;

FIG. 9B shows SAXS analysis results showing volume fractions according to the radius of micro pores and volume fractions according to the radius of macro pores in the cathode active materials according to Comparative Examples 1 and 2, and Example;

FIG. 10A is a charge/discharge profile of an electrochemical device according to Comparative Example 1; FIG. 10B is a charge/discharge profile of an electrochemical device according to Comparative Example 2; FIG. 10C is a charge/discharge profile of an electrochemical device according to Example;

FIG. 11 is a graph showing a capacity according to the number of cycles of the electrochemical devices according to Comparative Examples 1 and 2, and Example;

FIG. 12 shows X-ray absorption spectroscopy (XAS) results showing changes in the transition metal oxidation number of the cathode active materials in the electrochemical devices according to Comparative Examples 1 and 2, and Example;

FIG. 13A shows X-ray absorption spectroscopy results showing the oxidation number of Ni and Mn transition metals that changes during a charge/discharge process of the electrochemical device according to Comparative Example 1;

FIG. 13B shows X-ray absorption spectroscopy results showing the oxidation number of Ni and Mn transition metals that changes during a charge/discharge process of the electrochemical device according to Comparative Example 2; and

FIG. 13C shows X-ray absorption spectroscopy results showing the oxidation number of Ni and Mn transition metals that changes during a charge/discharge process of the electrochemical device according to Example.

### DETAILED DESCRIPTION OF EMBODIMENTS

In the present specification, singular expressions include plural expressions unless the context clearly indicates otherwise.

In the present specification, expressions such as first, second, (S1), (S2), and the like may modify various elements regardless of the order and/or importance thereof, and do not limit the corresponding elements. Such expressions may be used to distinguish one element from another. For example, a first element may be referred to as a second element, and in a similar manner, a second element may be referred to as a first element without departing the scope of rights of the present disclosure.

In the present specification, the range of numerical values expressed using the term ‘to’ indicates the range of numerical values including values described before and after the term as lower and upper limit values, respectively. For example, if a to b is described in the specification, it may be understood that equal to or higher than a to equal to or lower than b (a to b) is described.

In the present specification, if a plurality of numerical values are described as an upper limit and a lower limit of an arbitrary numerical range, respectively, the numerical range described in the present specification may be understood as an arbitrary numerical range having any one value among a plurality of lower limit values and any one value among a plurality of upper limit values as a lower limit value and an upper limit value, respectively. For example, if a or higher, or b or higher, and c or lower, or d or lower are described, it may be understood that equal to or higher than a to equal to or lower than c, equal to or higher than a to equal to or lower than d, equal to or higher than b to equal to or lower than c, or equal to or higher than b to equal to or lower than d is described.

In the present specification, a Small-Angle X-ray Scattering (SAXS) analysis method may be used to an analysis method capable of analyzing a scattering pattern generated when the X-ray interacts with a cathode active material, thereby identifying the size, volume, shape, distribution, and the like of pores.

According to an aspect of the present disclosure, there is provided a cathode active material including an overlithiated layered oxide (OLO), wherein R calculated in Equation 1 below is 27 or less.

$$R = ( {P}_{A} / {P}_{B} ) \qquad [ Equation l ]$$

In accordance with Small-Angle X-ray Scattering (SAXS): in Equation 1 above, P_{A} is the volume (cm³/g) of macro pores included in the cathode active material, and P_{B} is the volume (cm³/g) of micro pores included in the cathode active material, wherein the macro pores represent the highest volume fraction (cm³g⁻¹/Å) in a radius of 10^{2.5} Å to 10^{3.5} Å, and the micro pores represent the highest volume fraction in a radius of 10¹ Å to 10^{2.5} Å.

R defined in Equation 1 above is a parameter that varies depending on the content of a lithium source (lithium precursor), and is a parameter derived from experimental results in which the volume of macro pores (pore volume) decreases and the volume of micro pores (pore volume) increases in a cathode active material as the content of the lithium source decreases with respect to the a stoichiometric content. If the R in Equation 1 above is greater than the above-described numerical range, the radius of macro pores and the volume of the macro pores increase, which may result in a problem in that the performance of an electrochemical device, such as the charge capacity, the discharge capacity, and the coulombic efficiency, may decrease. According to an aspect of the present disclosure, since the R in Equation 1 above satisfies the above-described numerical range, it is possible to implement a cathode active material in which primary particles and secondary particles grow evenly and have excellent particle shape uniformity, thereby improving non-reversibility during a charge/discharge process caused by instability of oxidized oxygen. According to another aspect of the present disclosure, since the R in Equation 1 above is adjusted to be within the above-described numerical range, it is possible to implement a cathode active material capable of increasing a moving speed of lithium ions and increasing a charge/discharge rate of an electrochemical device.

Hereinafter, the configuration of the present disclosure will be described in more detail.

### 1. Cathode Active Material

A cathode active material according to the present disclosure includes an overlithiated layered oxide (OLO).

In the present specification, the overlithiated layered oxide is defined as a compound in which the molar ratio (Li/Metal molar ratio) of lithium with respect to all transition metals is greater than 1. For example, the overlithiated layered oxide may include one or more phases.

The cathode active material according to the present disclosure satisfies that R calculated in Equation 1 below is 27 or less.

$$R = ( {P}_{A} / {P}_{B} ) \qquad [ Equation l ]$$

In accordance with Small-Angle X-ray Scattering (SAXS): in Equation 1 above, P_{A} is the volume (cm³/g) of macro pores included in the cathode active material, and P_{B} is the volume (cm³/g) of micro pores included in the cathode active material, wherein the macro pores represent the highest volume fraction (cm³g⁻¹/Å) in a radius of 10^{2.5} Å to 10^{3.5} Å, and the micro pores represent the highest volume fraction in a radius of 10¹ Å to 10^{2.5} Å. Here, the radius refers the radius of each pore.

Small-Angle X-ray Scattering (SAXS) is a method of analyzing the structural properties of a nanomaterial by analyzing the intensity of X-ray scattering in a small-angle region. For example, if the Small-Angle X-ray Scattering (SAXS) analysis is performed on a cathode active material, the microstructure changes due to pores distributed inside the particles, so that the degree of scattering is exhibited different. By analyzing this, it is possible to output a graph of the radius of each pore (x-axis)—the volume fraction of the pore (y-axis) to analyze the structure of a porous material.

In the present disclosure, using the graph of the radius of each pore (x-axis)—the volume fraction of the pore (y-axis), the macro pores and micro pores in a typical overlithiated layered oxide cathode active material were distinguished, and finely controlled to manufacture a cathode active material having excellent electrochemical performance.

In some embodiments of the present disclosure, the R may be 27 or lower, 26 or lower, 25 or lower, 24 or lower, 23 or lower, 22 or lower, or 21 or lower, and specifically, may be 19 to any one of the plurality of upper limits, or may be 20 to any one of the plurality of upper limits. In some embodiments of the present disclosure, since the R is adjusted to be within the above-described numerical range, it is possible to implement a cathode active material in which primary particles and secondary particles grow evenly and have excellent particle shape uniformity, and accordingly, it is possible to improve non-reversibility during a charge/discharge process caused by instability of oxidized oxygen. In addition, since the R in Equation 1 above is adjusted to be within the above-described numerical range, it is possible to implement a cathode active material capable of increasing a moving speed of lithium ions and increasing a charge/discharge rate of an electrochemical device.

In some embodiments of the present disclosure, the cathode active material may include a compound represented by General Formula 1 below.

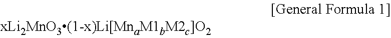

In General Formula 1 above, 0<x<1 and a+b+c=1, wherein 0<a<1, 0≤b<1, and 0≤c<1, and M1 and M2 are transition metals different from each other, which is Ni or Co. In the compound represented by General Formula 1 above, x may determine the mixing ratio of two phases. The compound represented by General Formula 1 above is an undoped overlithiated layered oxide, and may simultaneously achieve both an effect of increasing the capacity of an electrochemical device through xLi₂MnO₃, which represents a lithium excess state, and an effect of improving the structural stability and thermal stability of a cathode active material through (1−x)Li[MnₐM1_{b}M2_{c}]O₂.

In some other embodiments of the present disclosure, the cathode active material may include a compound represented by General Formula 2 below.

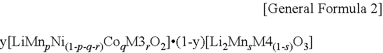

In General Formula 2 above, M3 and M4 are each independently one or more selected from the group consisting of Zr, Al, Re, V, Cr, Fe, Ga, Si, B, Ru, Ti, Nb, Mo, Mg, W, Na, and Pt, and 0.500<y<0.800, 0.450<p<0.650, 0≤q≤0.025, 0≤r≤0.100, and 0.900≤s≤1.000. Specifically, in the compound represented by General Formula 2 above, y may determine the mixing ratio of two phases. Unlike the compound of General Formula 1 above, the compound represented by General Formula 2 above may be an overlithiated layered oxide doped with M3 and M4. Specifically, since the compound represented by General Formula 2 above is doped with M3 and M4, it is possible to enhance the stability of a lithium-excess structure and improve long-term cycle performance.

In some embodiments of the present disclosure, in accordance with X-ray diffraction (XRD) analysis: a ratio I₍₀₀₃₎/I₍₁₀₄₎ of a diffraction X-ray intensity I₍₀₀₃₎ at a (003) peak to a diffraction X-ray intensity I₍₁₀₄₎ at a (104) peak may be 1.31 or greater. Specifically, the ratio I₍₀₀₃₎/I₍₁₀₄₎ of the diffraction X-ray intensity I₍₀₀₃₎ at the (003) peak to the diffraction X-ray intensity I₍₁₀₄₎ at the (104) peak may be 1.31 or greater, 1.32 or greater, 1.33 or greater, 1.34 or greater, or 1.35 or greater.

In some non-limiting examples, the ratio I₍₀₀₃₎/I₍₁₀₄₎ of the diffraction X-ray intensity I₍₀₀₃₎ at the (003) peak to the diffraction X-ray intensity I₍₁₀₄₎ at the (104) peak is a parameter that varies depending on the content of a lithium source (lithium precursor), and may be a factor that affects cation mixing due to Li⁺/Ni²⁺ site exchange.

In some embodiments of the present disclosure, since the ratio I₍₀₀₃₎/I₍₁₀₄₎ of the diffraction X-ray intensity I₍₀₀₃₎ at the (003) peak to the diffraction X-ray intensity I₍₁₀₄₎ at the (104) peak is adjusted to be within the above-described numerical range, cation mixing due to cation (e.g., Li⁺/Ni²⁺) site exchange may be reduced, thereby effectively preventing the movement path of lithium ions from being blocked.

In some embodiments of the present disclosure, in accordance with Small-Angle X-ray Scattering (SAXS): the macro pores may have a volume of 0.35 cm³/g to 0.45 cm³/g. Specifically, the volume of the macro pores may be 0.35 cm³/g or greater, 0.36 cm³/g or greater, or 0.37 cm³/g or greater, 0.38 cm³/g or greater, 0.39 cm³/g or greater, 0.40 cm³/g or greater, or 0.41 cm³/g or greater, and 0.42 cm³/g or less, 0.43 cm³/g or less, 0.44 cm³/g or less, or 0.45 cm³/g or less. In some embodiments of the present disclosure, since the volume of the macro pores is adjusted to be within the above-described numerical range, it is possible to implement a cathode active material in which primary particles and secondary particles grow evenly and have excellent particle shape uniformity, and accordingly, it is possible to improve non-reversibility during a charge/discharge process caused by instability of oxidized oxygen.

In some embodiments of the present disclosure, in accordance with Small-Angle X-ray Scattering (SAXS): the micro pores may have a volume of 0.017 cm³/g to 0.025 cm³/g. Specifically, the volume of the micro pores may be 0.017 cm³/g or greater, 0.018 cm³/g or greater, or 0.019 cm³/g or greater, or 0.020 cm³/g or greater, and 0.021 cm³/g or less, 0.022 cm³/g or less, 0.023 cm³/g or less, 0.024 cm³/g or less, or 0.025 cm³/g or less. In some embodiments of the present disclosure, since the volume of the micro pores is adjusted to be within the above-described numerical range, it is possible to implement a cathode active material in which primary particles and secondary particles grow evenly and have excellent particle shape uniformity, and accordingly, it is possible to improve non-reversibility during a charge/discharge process caused by instability of oxidized oxygen.

In some embodiments of the present disclosure, in accordance with Small-Angle X-ray Scattering (SAXS): the pores included in the cathode active material may have a total pore volume of 0.475 cm³/g or less. Specifically, the total pore volume of the pores included in the cathode active material may be 0.470 cm³/g or less, 0.46 cm³/g or less, or 0.45 cm³/g or less, and specifically, may be 0.40 cm³/g or greater to any one of the plurality of upper limits. In some embodiments of the present disclosure, since the volume of the pores included in the cathode active material is adjusted to be within the above-described numerical range, it is possible to implement a cathode active material in which primary particles and secondary particles grow evenly and have excellent particle shape uniformity, and accordingly, it is possible to improve non-reversibility during a charge/discharge process caused by instability of oxidized oxygen.

In the present specification, an average particle diameter of particles may be defined as a particle diameter (D₅₀) at which a cumulative percentage reaches 50% on a volume-based particle size distribution curve when measured by a laser diffraction particle size distribution measurement device. For example, the average particle diameter of particles may be measured by dispersing particles to be measured in a dispersion medium, and then introducing the mixture into a commercially available laser diffraction particle size measurement device (e.g., Microtrac S3500) to measure a difference in diffraction patterns according to a particle size when the particles pass through a laser beam, thereby calculating a particle size distribution.

In some embodiments of the present disclosure, the cathode active material may be a secondary battery in which primary particles are aggregated. In some non-limiting examples, the primary particles may have an average particle diameter of 50 nm to 100 nm, and the secondary particles may have an average particle diameter of 7 μm to 9 μm.

In some embodiments of the present disclosure, the cathode active material may have a grain size of 15 nm to 20 nm. For example, the grain size of the cathode active material may be calculated by X-ray diffraction (XRD) analysis and the Scherrer Equation.

### 2. Manufacturing Method of Cathode Active Material

In the present specification, a precursor is defined in chemistry as a compound that participates in a chemical reaction for producing another compound.

According another aspect of the present disclosure, there is provided a method for manufacturing a cathode active material, the method including S1 preparing a mixture including an overlithiated layered oxide precursor and a lithium precursor, and S2 heat-treating the mixture to manufacture a cathode active material, wherein in a manufacturing reaction of the cathode active material, the lithium precursor has a molar content lower than a stoichiometric molar content. Specifically, in a manufacturing reaction of the cathode active material, since the molar content of the lithium precursor is adjusted to be lower than a stoichiometric molar content, it is possible to implement a cathode active material in which primary particles and secondary particles grow evenly and have excellent particle shape uniformity, and which is capable of increasing a moving speed of lithium ions and increasing a charge/discharge rate of an electrochemical device.

An overlithiated layered oxide precursor according to the present disclosure is a precursor of an overlithiated layered oxide. In some non-limiting examples, the overlithiated layered oxide precursor may include Ni_{0.25}Mn_{0.75}CO₃.

In some non-limiting examples, the lithium precursor may be a lithium salt in which lithium and an anion are bonded, specifically lithium carbonate. Alternatively, the lithium precursor may be referred to as a lithium source.

In some embodiments of the present disclosure, the molar content of the lithium precursor may be lower than the stoichiometric molar content by 0.5 mol % to 3 mol %. In some embodiments of the present disclosure, by adjusting the molar content of the lithium precursor to the above-described numerical range with respect to the stoichiometric molar content, it is possible to implement a cathode active material in which primary particles and secondary particles grow evenly and have excellent particle shape uniformity, and accordingly, it is possible to improve non-reversibility during a charge/discharge process caused by instability of oxidized oxygen.

In some embodiments of the present disclosure, the step S2 may include heat-treating the mixture at 800° C. to 1100° C. for 0.5 hours to 15 hours under an atmospheric atmosphere. Specifically, the heat treatment temperature of the mixture may be 800° C. or higher, 850° C. or higher, or 900° C. or higher, and 950° C. or lower, 1000° C. or lower, 1050° C. or lower, or 1100° C. or lower, and the heat treatment duration may be 0.5 hours or more, 0.7 hours or more, 0.9 hours or more, or 1 hour or more, and 1.2 hours or less, 1.4 hours or less, 1.6 hours or less, 1.8 hours or less, 2.0 hours or less, 5.0 hours or less, 10.0 hours or less, or 15.0 hours or less. In some embodiments of the present disclosure, since the heat treatment temperature and the heat treatment duration of the mixture are adjusted to be within the above-described numerical ranges, it is possible to implement a cathode active material in which primary particles and secondary particles grow evenly and have excellent particle shape uniformity, and accordingly, it is possible to improve non-reversibility during a charge/discharge process caused by instability of oxidized oxygen.

### 3. Cathode

According to yet another aspect of the present disclosure, there is provided a cathode including a cathode active material of some embodiments.

The cathode according to the present disclosure may include a cathode current collector and a cathode active material layer disposed on least one surface of the cathode current collector. The cathode active material layer may include the cathode active material, a conductive material, and a cathode binder.

For example, the cathode current collector is not particularly limited as long as it has high conductivity without causing a chemical change in a battery. Specifically, as the cathode current collector, copper, stainless steel, aluminum, nickel, titanium, fired carbon, copper or stainless steel that is surface-treated with one of carbon, nickel, titanium, silver, and the like, an aluminum-cadmium alloy, and the like may be used. The cathode current collector may typically have a thickness of 6 μm to 20 μm.

The conductive material may improve conductivity between active material particles or with a metal current collector in an electrode, and may prevent a binder from acting as a non-conductor. The conductive material may be, for example, one or a mixture of two or more conductive materials selected from the group consisting of graphite, carbon black, carbon fiber, metal fiber, metal powder, a conductive whisker, a conductive metal oxide, activated carbon and a polyphenylene derivative, and more specifically, may be one or a mixture of two or more conductive materials selected from the group consisting of natural graphite, artificial graphite, Super-p, acetylene black, Ketjen black, channel black, furnace black, lamp black, thermal black, Denka black, aluminum powder, nickel powder, zinc oxide, potassium titanate, and titanium oxide.

For example, the cathode binder may be poly(vinylidene fluoride co-hexafluoropropylene), poly(vinylidene fluoride-co-trichloroethylene), poly(methylmethacrylate), poly(ethylhexylacrylate), poly(butylacrylate), poly(acrylonitrile), poly(vinylpyrrolidone), poly(vinyl acetate), poly(ethylene-co-vinyl acetate), poly(ethylene oxide), polyacrylate, cellulose acetate, cellulose acetate butyrate, cellulose acetate propionate, cyano ethyl pullulan, cyano ethyl poly(vinylalcohol), cyanoethylcellulose, cyano ethylsucrose, pullulan, and carboxyl methyl cellulose, but is not limited thereto.

### 4. Electrochemical Device

In the present specification, an “electrochemical device” is defined as any device that performs an electrochemical reaction. For example, the electrochemical device may be a secondary battery or a supercapacitor, and specifically, may be a lithium metal battery, or a lithium ion secondary battery.

### Anode

An anode according to the present disclosure may include an anode current collector and an anode active material layer disposed on least one surface of the anode current collector, or a lithium (Li) metal.

For example, the anode active material layer may include the anode active material, a conductive material, and an anode binder.

The anode current collector may serve as a passage for transferring electrons from the outside or receiving electrons from the anode active material to transmit the electrons to the outside such that an electrochemical reaction occurs in the anode active material. For example, as the anode current collector, copper, stainless steel, aluminum, nickel, titanium, fired carbon, or aluminum or stainless steel that is surface-treated with one of carbon, nickel, titanium, silver, and the like may be used, and specifically, a transition metal which adsorbs carbon such as copper and nickel well may be used as the current collector. For example, the anode current collector may have a thickness of 6 μm to 20 μm, but the thickness of the anode current collector is not limited thereto.

The conductive material included in the anode may be the same as or different from the conductive material included in the cathode.

If necessary, the anode material layer may further include an additive. The additive may be, for example, at least one selected from the group consisting of a dispersant, a plasticizer, an antioxidant, a lubricant, a stabilizer, and an antistatic agent.

### Separator

A separator according to the present disclosure includes a porous substrate to electrically insulate an anode and a cathode to prevent a short circuit.

An organic material or an inorganic material having electrical insulation may be used without a particular limitation as long as it is a constituent material of the porous substrate. The porous substrate may include, for example, at least one selected from the group consisting of polyolefin, polyethylene terephthalate, polybutylene terephthalate, polyacetal, polyamide, polycarbonate, polyimide, polyetheretherketone, polyethersulfone, polyphenylene oxide, polyphenylene sulfide, and polyethylenenaphthalene, and specifically, may include polyolefin. Polyolefin not only exhibits excellent coating properties, but may also reduce the thickness of a separator, thereby increasing the ratio of an electrode active material layer in a battery to increase a capacity per unit volume. Specifically, the polyolefin may have a weight average molecular weight (M_{w}) of 100,000 g/mol to 500,000 g/mol. If the weight average molecular weight of the polyolefin is less than the above-described numerical range, it may be difficult to secure sufficient mechanical properties, and if the weight average molecular weight of the polyolefin is greater than the above-described numerical range, a shut-down function may not be implemented or molding may be difficult to be performed. The shutdown function refers to a function of dissolving a thermoplastic resin when the temperature of a secondary battery increases, thereby closing pores of a porous substrate to block movement of ions and prevent thermal runaway of the battery.

The porous substrate may have a thickness of, for example, 3 μm to 12 μm or 5 μm to 12 μm. If the thickness of the porous substrate is less than the numerical range, the porous substrate may not sufficiently function as a conductive barrier, and if greater than the numerical range, the resistance of a separator may excessively increase.

The average diameter of pores included in the porous substrate may be, for example, 10 nm to 100 nm. The pores included in the porous substrate are connected to each other, so that a gas or a liquid may pass through from one surface of the porous substrate to the other surface thereof.

According to some embodiments of the present disclosure, a coating layer may be disposed on at least one surface of the porous substrate. Specifically, the coating layer may improve mechanical strength and heat resistance of a separator and increase ionic conductivity in a secondary battery.

The coating layer according to the present disclosure may include a binder polymer and inorganic particles.

The binder polymer according to the present disclosure may be stably fixed while connecting the inorganic particles. The binder polymer may be used by mixing, for example, one or a mixture of two or more selected from the group consisting of polyvinylidene fluoride-co-hexafluoropropylene, polyvinylidene fluoride-co-trichloroethylene, polymethylmethacrylate, polyacrylonitrile, polyvinylpyrrolidone, polyvinylacetate, poly(ethylene-co-vinyl acetate), polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, Pullulan, carboxyl methyl cellulose, acrylonitrile-styrene butadiene copolymer, polyimide, and styrene-butadiene rubber.

According to another embodiment of the present disclosure, a weight ratio (inorganic particles:binder polymer) of the inorganic particles and the binder polymer may be 50:50 to 99:1, specifically 70:30 to 95:5. If the content ratio of the inorganic particles to the binder polymer is less than the above-described numerical range, the content of the binder polymer increases, which may degrade the thermal safety improvement performance of a separator, and due to the reduction in an empty space formed between the inorganic particles, the pore size and the porosity decrease, which may cause degradation in the performance of a final battery, and if greater than the above-described numerical range, the content of the binder polymer is too low, which may weaken the peeling resistance of a coating layer.

Inorganic particles according to the present disclosure may contribute to improving mechanical strength and heat resistance of a separator for a secondary battery. Specifically, the inorganic particles are not particularly limited as long as they are electrochemically stable. That is, the inorganic particles that can be used in the present disclosure are not particularly limited as long as oxidation and/or reduction reactions do not occur within an operating voltage range of a secondary battery (e.g., 0 V to 5 V based on Li/Li⁺).

As an example, if inorganic particles having high permittivity are used as the inorganic particles, the inorganic particles contribute to increasing the degree of dissociation of an electrolyte salt, such as a lithium salt, in a liquid electrolyte, which may improve the ionic conductivity of the electrolyte. For the above-described reasons, the inorganic particles may be inorganic particles having a dielectric constant of 5 or greater, inorganic particles having lithium ion transport capability, or a mixture thereof.

The inorganic particles having a dielectric constant of 5 or greater may be one or more selected from the group consisting of Al₂O₃, SiO₂, ZrO₂, AlO(OH), Al(OH)₃, Mg(OH)₂, BaSO₄, TiO₂, BaTiO₃, Pb(ZrₓTi₁₋ₓ)O₃ (PZT, wherein 0<x<1), Pb₁₋ₓLaₓZr_{1-y}Ti_{y}O₃ (PLZT, wherein 0<x<1, and 0<y<1), (1−x)Pb(Mg_{1/3}Nb_{2/3})O₃₋ₓPbTiO₃ (PMN-PT, wherein 0<x<1), HfO₂, SrTiO₃, SnO₂, CeO₂, MgO, NiO, CaO, ZnO, and SiC.

The inorganic particles having lithium ion transport capability may include lithium phosphate (Li₃PO₄), lithium titanium phosphate (LiₓTi_{y}(PO₄) 3, 0<x<2, 0<y<3), lithium titanium phosphate (LiₓAl_{y}Ti_{z}(PO₄)₃, 0<x<2, 0<y<1, 0<z<3), (LiAlTiP)ₓO_{y} series glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitride (LiₓN_{y}, 0<x<4, 0<y<2), SiS₂ series glass (LiₓSi_{y}S_{z}, 0<x<3, 0<y<2, 0<z<4), and P₂S₅ series glass (LiₓP_{y}S_{z}, 0<x<3, 0<y<3, 0<z<7).

For example, the average particle diameter (D₅₀) of the inorganic particles may be 1 nm to 10 μm, specifically 10 nm to 2 μm, more specifically 50 nm to 1 μm, in order to form a coating layer having a uniform thickness and appropriate porosity. The “average particle diameter (D₅₀)” means a particle diameter at a point of 50% in the cumulative distribution of the number of particles according to a particle diameter. The average particle diameter may be measured using a laser diffraction method. Specifically, the average particle diameter may be measured by dispersing powder to be measured in a dispersion medium, and then introducing the mixture into a commercially available laser diffraction particle size measurement device (e.g.: Microtrac S3500) to measure a difference in diffraction patterns according to a particle size when the particles pass through a laser beam, thereby calculating a particle size distribution.

### Electrolyte

An electrolyte according to the present disclosure may include a solvent, and a lithium salt.

The solvent according to the present disclosure may be one or a mixture of two or more selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone, ethyl methyl carbonate (EMC), gamma-butyrolactone (GBL), fluoroethylene carbonate (FEC), methyl formate, ethyl formate, propyl formate, methyl acetate, ethyl acetate, propyl acetate, pentyl acetate, methyl propionate, ethyl propionate, ethyl propionate, and butyl propionate.

The lithium salt according to the present disclosure may include anions, for example, NO₃⁻, F⁻, Cl⁻, Br⁻, I⁻, PF₆⁻, and the like.

A secondary battery according to the present disclosure may be a cylindrical, rectangular, or pouch-type secondary battery, but is not particularly limited as long as it is a charging/discharging device.

According to an aspect of the present disclosure, there may be provided a battery module including the electrochemical device as a unit cell, and a battery pack including the same. The battery pack may be used, for example, as a power source of one or more medium-and-large sized devices selected from the group consisting of a power tool, electric cars including an electric vehicle (EV), a hybrid electric vehicle (HEV), and a plug-in hybrid electric vehicle (PHEV), or a system for power storage.

Hereinafter, embodiments of the present invention will be described in detail so that those skilled in the art to which the present invention belongs may easily implement the present invention, but this is merely an example, and the scope of rights of the present invention is not limited by the following contents. In the present specification, a term such as “about” or “substantially” refers to a reasonable amount of deviation of a term modified such that a final result does not significantly change. These terms may be interpreted as including a deviation of at least ±5% or at least ±10% within a limit in which the deviation does not modify and invalidate the meaning of a word.

### [Manufacturing Preparation Example: Preparation of Co-Precipitation Precursor]

A Ni_{0.25}Mn_{0.75}CO₃ co-precipitation precursor provided by the Korea Atomic Energy Research Institute (KAERI) was prepared.

### Experimental Example 1: SEM-EDS Analysis Results of Co-Precipitation Precursor

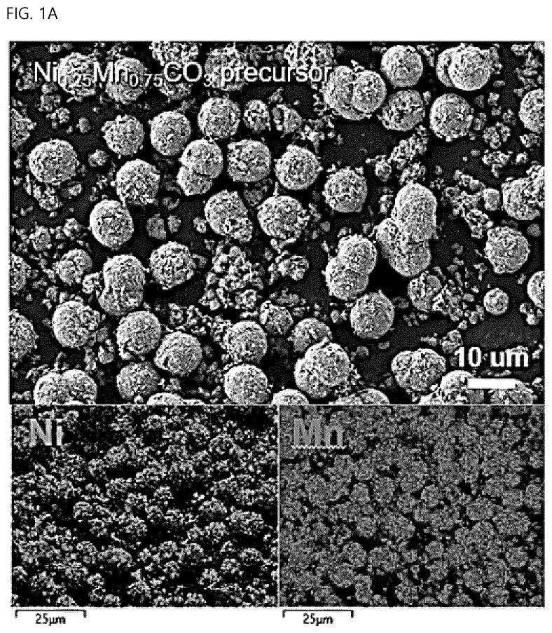

FIG. 1A shows Scanning Electron Microscopy-Energy Dispersive X-ray Spectroscopy (SEM-EDS) analysis results of Ni_{0.25}Mn_{0.75}CO₃ according to Manufacturing Preparation Example.

Referring to FIG. 1A, it can be inferred that the particle size of the co-precipitation precursor is about 7 μm to 8 μm, and Ni and Mn are evenly distributed in a molar ratio of 1:3.

FIG. 1B shows X-ray diffraction (XRD) analysis results of Ni_{0.25}Mn_{0.75}CO₃ of Manufacturing Preparation Example. Specifically, a Mo Ka(λ=0.71 Å) wavelength of a Malvern PANalytical Empyrean model was used, and the measurement was performed with a step size of 0.016° in an angle range of 2θ=5 to 35°.

Referring to FIG. 1B, it was confirmed that a R-3c space group matched well with an existing Ref and no other impurities were observed.

### Manufacturing Example 1: Manufacturing of Cathode Active Material

### Preparing Mixture by Mixing Precursor

A Ni_{0.25}Mn_{0.75}CO₃ precursor and Li₂CO₃ were weighed according to compositions described in Table 1 below, and then mixed for 30 minutes using an Agate mortar pestle to prepare a mixture.

### Heat-Treating Mixture

The mixture was introduced into an alumina boat and tapped, and heat-treated in an electric furnace at 900° C. for 1 hour under an atmospheric atmosphere to manufacture a cathode active material.

TABLE 1

| | | Molar ratio of | |
|---|---|---|---|
| Classification | Chemical Formula | Ni_{0.25}Mn_{0.75}CO₃ [symbol] Li₂CO₃ | Mol % of Li₂CO₃ |
| Comparative Example 1 | Li_{1.2}Ni_{0.2}Mn_{0.6}O₂ | Stoichiometric molar ratio 1:0.75 | About 42.8 mol % (Reference) |
| Comparative Example 2 | Li_{1.26}Ni_{0.2}Mn_{0.6}O₂ | Stoichiometric molar ratio 1:0.7875 | About 44.1 mol % (Reference +5 mol %; Excess) |
| Example | Li_{1.176}Ni_{0.2}Mn_{0.6}O₂ | Stoichiometric molar ratio 1:0.735 | About 42.4 mol % (Reference −2 mol %; Less) |

### Experimental Example 2: XRD Analysis of Cathode Active Material

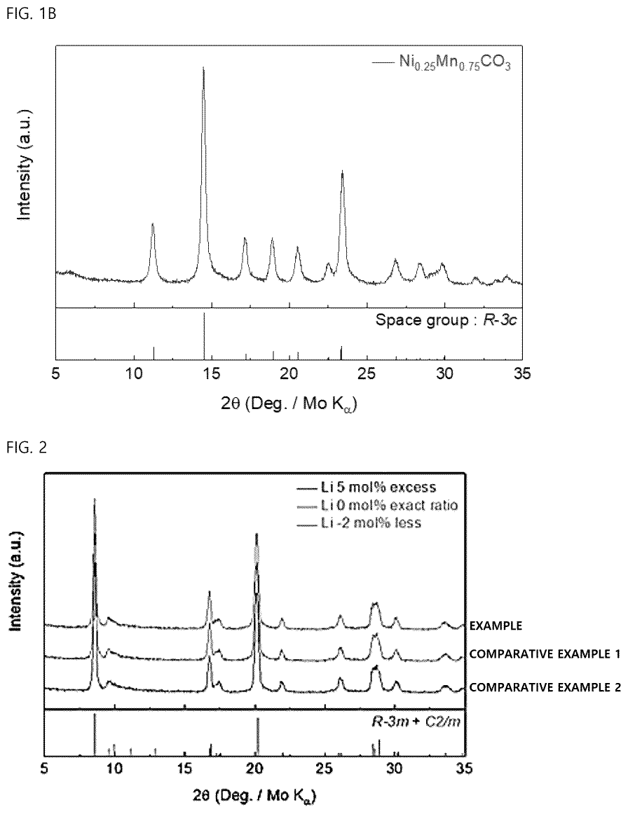

FIG. 2 shows XRD analysis results of the cathode active materials according to Comparative Examples 1 and 2, and Example. Specifically, a Mo Ka(λ=0.71 Å) wavelength of a Malvern PANalytical Empyrean model was used, and the measurement was performed with a step size of 0.016° in an angle range of 2θ=5 to 35°.

Referring to FIG. 2, it was confirmed that all of the cathode active materials according to Comparative Examples 1 and 2 and Example exhibited an overlithiated layered structure composed of R-3m and C2/m space groups.

### Experimental Example 3: XRD Analysis of Cathode Active Material

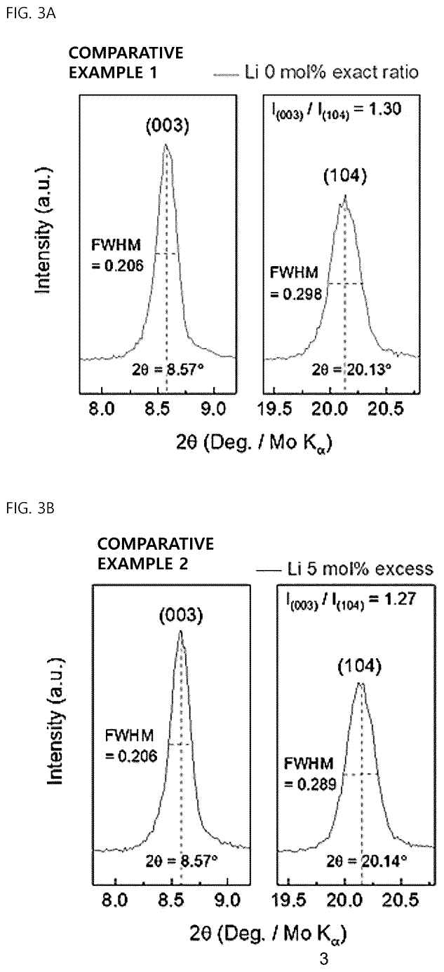

FIG. 3A shows XRD analysis results of the cathode active material according to Comparative Example 1. FIG. 3B shows XRD analysis results of the cathode active material according to Comparative Example 2. FIG. 3C shows XRD analysis results of the cathode active material according to Example.

Specifically, a Mo Ka(λ=0.71 Å) wavelength of a Malvern PANalytical Empyrean model was used, and the measurement was performed with a step size of 0.016° in an angle range of 2θ=5° to 35°. Through Experimental Example 3 above, for each of the cathode active materials manufactured, full-width-half-maximum (FWHM) of (003) and (104) peaks, and a ratio I₍₀₀₃₎/I₍₁₀₄₎ of an intensity I₍₀₀₃₎ at the (003) peak to an intensity I₍₁₀₄₎ at the (104) peak were calculated.

Referring to FIGS. 3A to 3C, it was confirmed that as the content of the lithium source was adjusted, the position and FWHM of the XRD peak were not significantly changed. On the other hand, it was confirmed that as the content of the lithium source was lowered, the I₍₀₀₃₎/I₍₁₀₄₎ tended to increase. Through this, it can be inferred that by lowering the content of the lithium source (lithium precursor) with respect to the stoichiometric molar ratio, cation mixing due to Li⁺/Ni²⁺ site exchange may be reduced, thereby effectively preventing the movement path of lithium ions from being blocked.

Specifically, it was confirmed that the ratio I₍₀₀₃₎/I₍₁₀₄₎ of the intensity I₍₀₀₃₎ at the (003) peak to the intensity I₍₁₀₄₎ at the (104) peak of the cathode active material according to Example was 1.35 or greater.

### Experimental Example 4: Analysis of SEM Photograph and Shape of Cathode Active Material

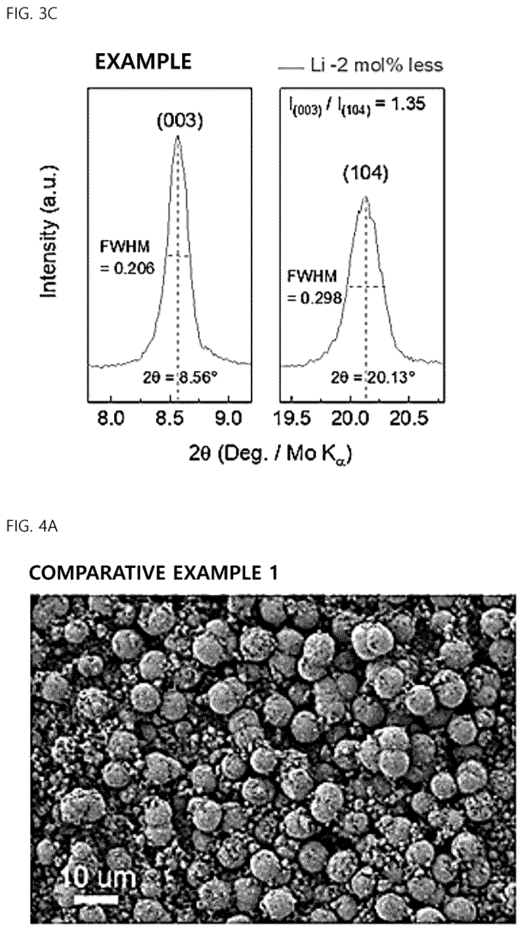

FIG. 4A is a scanning electron microscope (SEM) photograph of the cathode active material according to Comparative Example 1, and FIG. 4B is an enlarged SEM photograph of FIG. 4A.

Referring to FIGS. 4A and 4B, it was confirmed that primary particles and secondary particles were evenly grown compared to Comparative Example 2 to be described later, but some particles were unevenly grown.

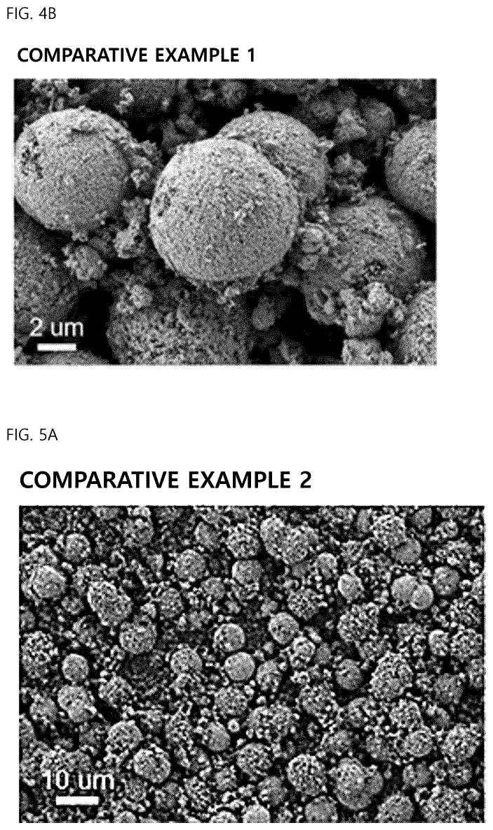

FIG. 5A is a SEM photograph of the cathode active material according to Comparative Example 2, and FIG. 5B is an enlarged SEM photograph of FIG. 5A.

Referring to FIGS. 5A and 5B, it was observed that primary particles were excessively grown compared to Ni₂₅Mn₇₅CO₃, and it was observed that secondary particles were indiscriminately grown, thereby degrading uniformity.

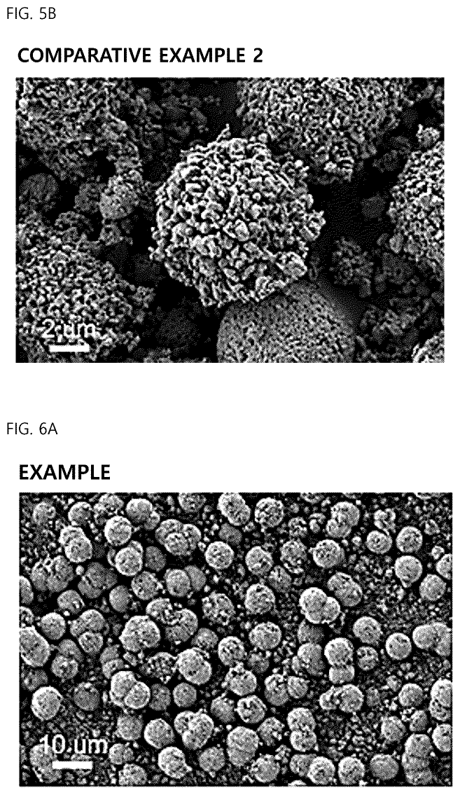

FIG. 6A is a SEM photograph of the cathode active material according to Example, and FIG. 6B is an enlarged SEM photograph of FIG. 6A.

Referring to FIGS. 6A and 6B, the cathode active material according to Example of the present disclosure showed an effect in that primary particles and secondary particles were evenly grown and particle shape uniformity was significantly improved.

### Experimental Example 5: TEM Cross-Section Image of Cathode Active Material

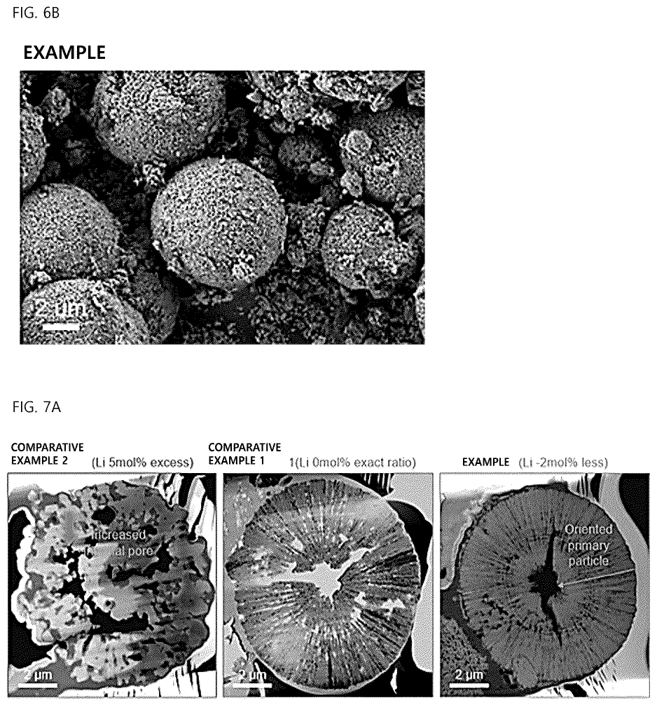

FIG. 7A shows transmission electron microscope (TEM) photographs of cross-sections of the cathode active materials according to Comparative Examples 1 and 2 and Example.

Referring to FIG. 7A, in the case of Comparative Example 2, it was confirmed that large internal pores were formed due to the indiscriminate growth of primary particles. Comparing Comparative Example 2 with Comparative Example 1 and Example, it was confirmed that as the lithium source content was lowered, the primary particles were aligned in the direction of the particle center, so that the size of the internal pores decreased.

FIG. 7B shows TEM photographs showing atomic arrangement analysis of the cathode active materials according to Comparative Examples 1, 2, and Example.

Referring to FIG. 7B, in Comparative Example 2, a rock salt-salt layer was formed on the surface of the cathode active material, whereas a spinel structure was confirmed to be formed thin and uniform on the surface of the cathode material of Example. The rock-salt structure is an electrochemically inactive phase, and thus, is highly resistant to the movement of lithium ions or charge transfer. Such physical properties lower the moving speed of lithium ions within the rock salt structure, and due to the same crystal orientation as the inner layered structure, the irregular growth of particles is not suppressed.

On the other hand, due to the spinel structure formed on the surface of the cathode active material according to Example, the irregular growth of primary particles is suppressed and the primary particles are arranged while having orientation within a secondary particle, so that it can be inferred that the moving speed of lithium ions may increase. Through this, it can be inferred that the charge/discharge rate of an electrochemical device may also be improved.

### Experimental Example 6: Analysis of Particle Surface Electronic Structure Through Electron Energy Loss Spectroscopy

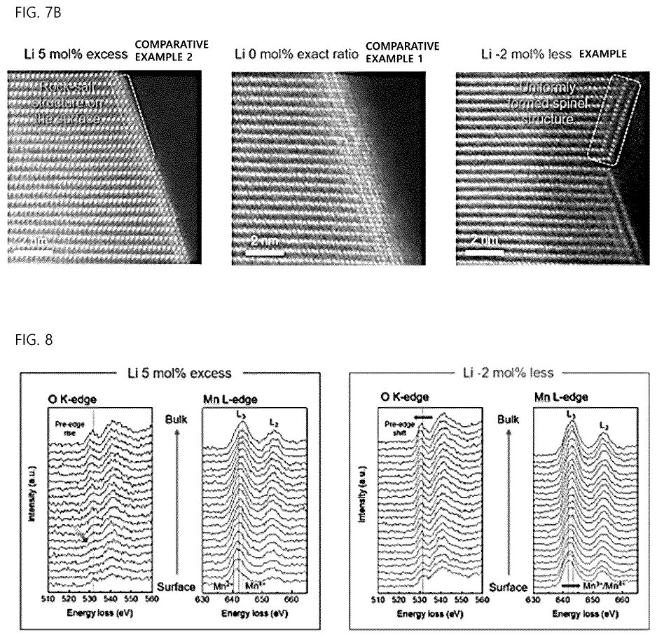

FIG. 8 shows electron energy loss spectroscopy results for the cathode active materials according to Comparative Example 2 and Example.

Referring to FIG. 8, in Comparative Example 2, some Mn²⁺ was detected at the Mn L-edge, which was confirmed to be due to the M²⁺O²⁻ rock-salt layer formed on the surface. In the cathode active material of Example, Mn³⁺ was found only near the surface, which was confirmed to be due to Mn present within the LiMn^{3.5+}₂O₄ spinel structure.

### Experimental Example 7: Pore Analysis of Cathode Active Material Using Small-Angle X-Ray Scattering Analysis

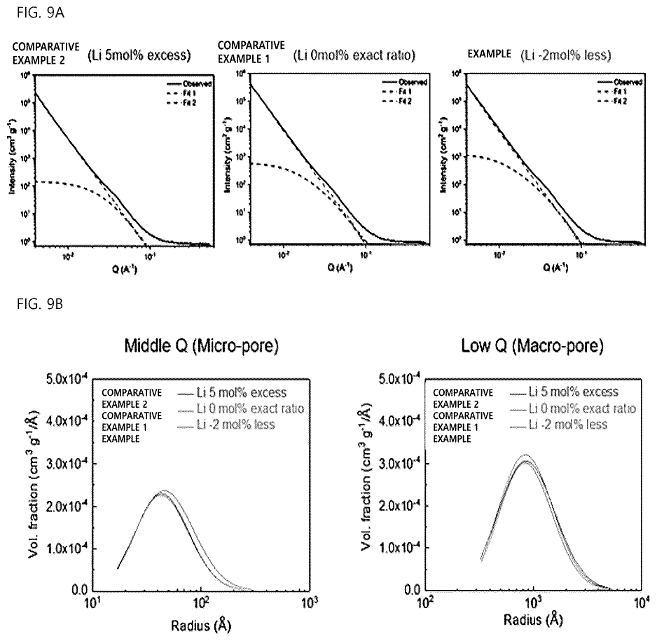

FIG. 9A shows Small-Angle X-ray Scattering (SAXS) analysis results of the cathode active materials according to Comparative Examples 1 and 2, and Example. Here, the SAXS graph is a graph showing the intensity of X-ray according to a scattering vector (Q).

FIG. 9B shows SAXS analysis results showing volume fractions according to the radius of micro pores and volume fractions according to the radius of macro pores in the cathode active materials according to Comparative Examples 1 and 2, and Example.

Specifically, the manufactured overlithiated layered cathode material was evenly dispersed on a tape and sampled. Lab-SAXS equipment manufactured by NANOPIX, Rigaku was used by using a Cu Ka(wavelength: 1.54 Å) value, wherein and the sample-to-detector distances (SDDs) were 1.3 m and 0.15 m for measurement.

In this case, the measurement conditions were set to a Q range of 0.003 to 0.13 Å. Here, Q=[4π/λ]*sin (θ/2), wherein Q is the magnitude of a scattering vector, and theta is a scattering angle. Data calibration was performed using the standard material, AgBe (silver behenate), and data analysis was performed using an available program, HANARO SANS data reduction software (provided by KAERI), in Igor program.

Table 2 below summarizes the pore volume for each pore according to the Small-Angle X-ray Scattering (SAXS) analysis.

TABLE 2

| | Macro pore | Micro pore | Total pore | R = |
|---|---|---|---|---|
| Classification | volume (P_{A}) | volume (P_{B}) | volume | P_{A}/P_{B}* |
| Comparative Example | 0.4744 | 0.0167 | 0.4911 | 28.4072 |
| 2 (Li 5 mol %) | cm³g⁻¹ | cm³g⁻¹ | cm³g⁻¹ | |
| Comparative Example | 0.4650 | 0.0165 | 0.4815 | 28.1818 |
| 1 (Li 0 mol %) | cm³g⁻¹ | cm³g⁻¹ | cm³g⁻¹ | |
| Example | 0.4200 | 0.0202 | 0.4402 | 20.7921 |
| (Li −2 mol %) | cm³g⁻¹ | cm³g⁻¹ | cm³g⁻¹ | |

*Value rounded to the fourth decimal place

Referring to Table 2, FIGS. 9A and 9B, it was confirmed that the larger the content of the lithium source, the higher the radius and the pore volume of the macro pores. In addition, it was confirmed that the lower the content of the lithium source, the lower the total pore volume.

In the present disclosure, when preparing an overlithiated layered oxide cathode active material, unlike a typical case in which a lithium source is added in an excess amount, the content of a lithium source to be added was reduced, so that it was possible to precisely control macro pores and micro pores in a cathode active material, which resulted in implementing uniform growth of cathode active material particles and excellent electrochemical performance.

### Manufacturing Example 2: Manufacturing of Coin-Cell

### Manufacturing of Cathode:

Mixed powder obtained by mixing the cathode active material of Manufacturing Example 1, a conductive material (Super P), and a binder (polyvinylidene fluoride) in a weight ratio of 80:10:10 was added to a solvent (N-methyl pyrrolidone), and then the mixture was mixed at 20 rpm for 1 hour using a Pulverisette 23 Mini Mill to manufacture a cathode slurry having a total solid content of 50 wt %. The manufactured cathode slurry was coated on one surface of an aluminum current collector (thickness: about 15 μm) to about 3 mg/cm², and then dried in a vacuum oven at 100° C. for 12 hours to manufacture a cathode.

### Preparation of Counter Electrode (Anode):

A lithium metal (thickness: about 1 mm) was prepared as a counter electrode.

### Preparation of Separator:

A separator (Celgard®2400, thickness: about 25 μm) made of a single layer of polypropylene was prepared.

### Injecting Electrolyte:

An electrode assembly composed of the cathode, the separator, and the counter electrode and an electrolyte were injected into a glove box under an argon atmosphere, and assembled into a CR-2032-type coin-cell. In this case, as the electrolyte, an electrolyte prepared by dissolving 1.2 M of LiPF₆ in a mixed solvent in which ethylene carbonate, dimethyl carbonate, and ethyl methyl carbonate were mixed in a volume ratio of 2:4:4 was used.

### Experimental Example 8: Evaluation of Charge/Discharge Performance of Coin-Cell

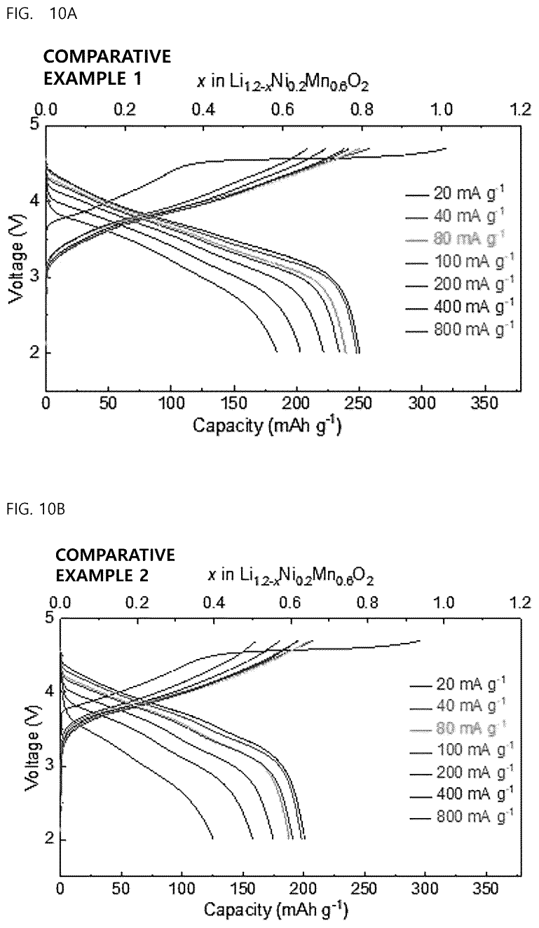

FIG. 10A is a charge/discharge profile of the coin-cell according to Comparative Example 1. FIG. 10B is a charge/discharge profile of the coin-cell according to Comparative Example 2. FIG. 10C is a charge/discharge profile of a coin-cell according to Example. Specifically, the charge/discharge performance was evaluated using a battery charger/discharger at 30° C., and a current density of (1C=250 mA/g) and a voltage of 2.0 V to 4.7 V (vs. Li/Li⁺).

TABLE 3

| | | | 1^{st} | Initial |
|---|---|---|---|---|
| | | 1^{st} charge | discharge | coulombic |
| | R = | capacity | capacity | efficiency |
| Classification | P_{A}/P_{B}* | (mAh/g) | (mAh/g) | (%) |
| Comparative Example | 28.4072 | 295.2 | 200.8 | 68 |
| 2 (Li 5 mol %) | | | | |
| Comparative Example | 28.1818 | 318.7 | 250.4 | 78.6 |
| 1 (Li 0 mol %) | | | | |
| Example (Li −2 mol %) | 20.7921 | 341.5 | 277.1 | 81.1 |

*Value rounded to the fourth decimal place
Initial coulombic efficiency = (1^{st} discharge capacity/1^{st} charge capacity) × 100

Referring to FIG. 10A to 10C, and Table 3 above, compared to Comparative Examples 1 and 2, Example satisfies the ratio of the volume of macro pores to the volume of micro pores of 27 or less, and thus, was confirmed to have an effect in that the initial charge capacity, the initial discharge capacity, and the initial coulombic efficiency were all increased.

### Experimental Example 9: Evaluation of Lifespan Performance of Coin-Cell

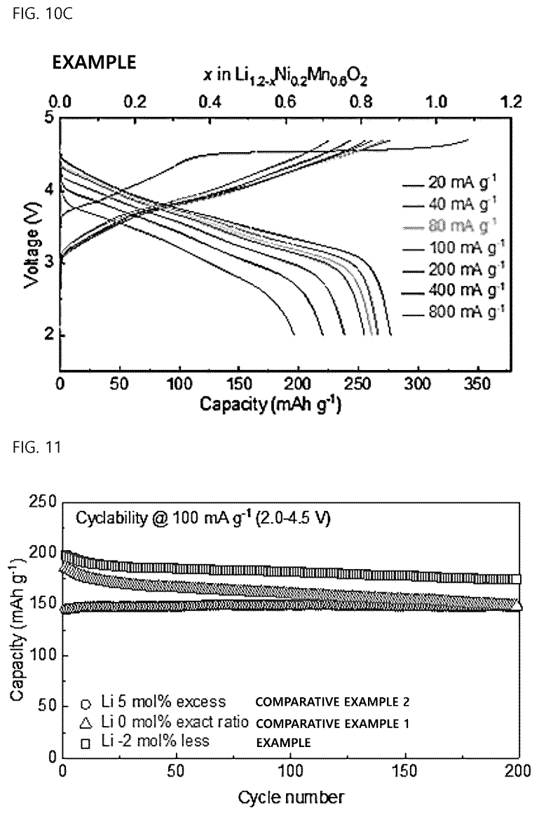

FIG. 11 is a graph showing a capacity according to the number of cycles of the coin-cells according to Comparative Examples 1 and 2, and Example. The lifespan of each of the coin-cells was evaluated in the same manner as in Experimental Example 8, except that after performing the initial formation at 2.0 V to 4.7 V (vs. Li/Li⁺), the upper voltage was set to 4.5 V (vs. vs. Li/Li⁺).

Referring to FIG. 11, it was confirmed that Comparative Example 2 (Li 5 mol %) showed a tendency that the capacity gradually increased over continuous cycles due to the initial capacity not being implemented, but the reversible capacity itself was very low, whereas Comparative Example 1 (Li 0 mol %) showed that the capacity of the electrochemical device decreased relatively quickly, thereby maintaining 80% of the initial capacity after 200 charge-discharge cycles.

On the other hand, Example (Li-2 mol %) showed the highest capacity and retention rate (90%), so that it was confirmed that the difference in electrochemical performance was significantly prominent according to the particle shape of the manufactured overlithiated layered cathode active material.

### Experimental Example 10: Analysis of Change in Transition Metal Oxidation Number

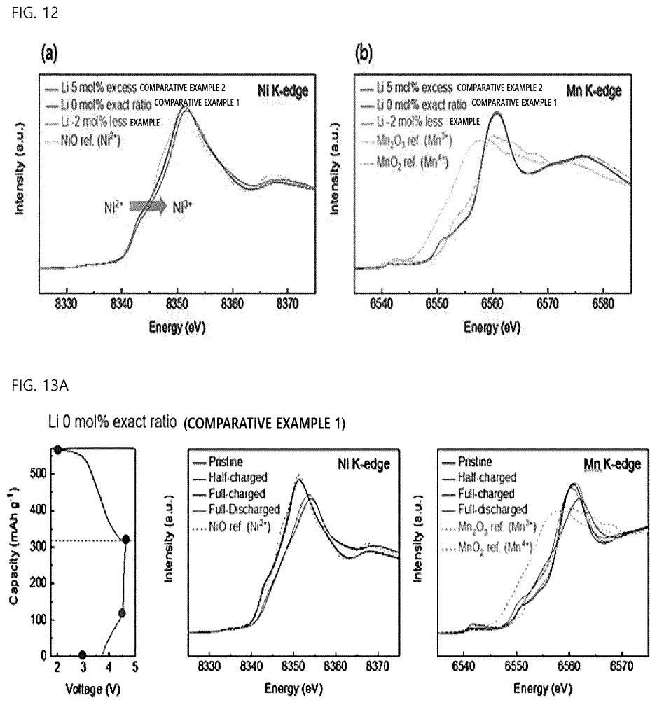

FIG. 12 shows X-ray absorption spectroscopy (XAS) results showing a change in the transition metal oxidation number of the cathode active material in the coin-cell according to each of Comparative Examples 1 and 2, and Example. Specifically, (a) of FIG. 12 shows results of measuring Ni K-edge, and (b) of FIG. 12 shows results of measuring Mn K-edge.

The charged/discharged coin-cell was disassembled in an glove box under an Ar atmosphere, and then the separated electrode was immersed in a dimethyl carbonate solution to remove foreign substances formed on the surface of the electrode. After sealing with a polyimide film to block contact with external air, Ni K-edge/Mn K-edge regions were measured using a 7D-XAFS beamline of Pohang Accelerator Laboratory.

Referring to FIG. 12, it was confirmed that in Comparative Example 2 (Li 5 mol %), Ni was partially further oxidized, and Mn showed the same 4+ oxidation number in all samples of Comparative Examples and Example.

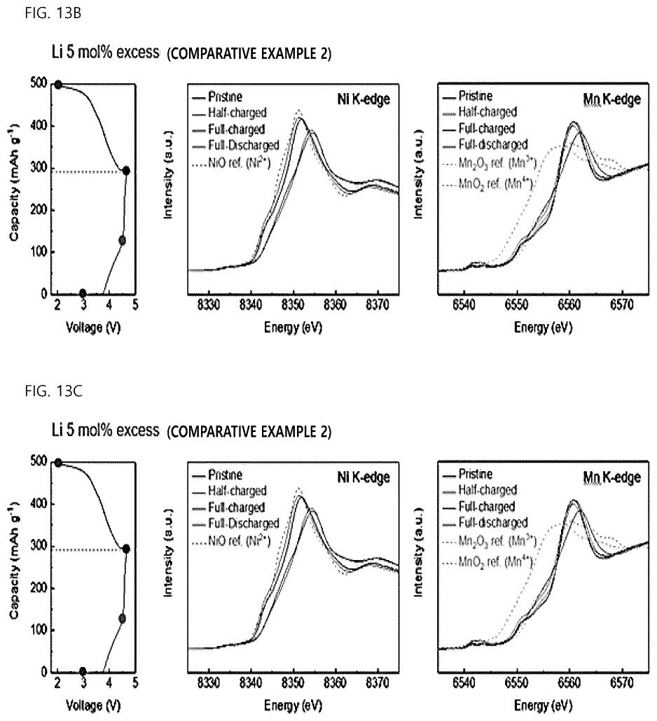

FIG. 13A shows X-ray absorption spectroscopy results showing the oxidation number of Ni and Mn transition metals that changes during a charge/discharge process of the coin-cell according to Comparative Example 1.

Comparing Pristine and Full discharged in FIG. 13A, it was confirmed that the oxidation number of Ni was recovered to the initial state even after the charge/discharge, but Mn was partially reduced at Full discharged (fully-discharged state). This is thought to be due to the fact that Mn exerted a large capacity, thereby causing some of the material to deteriorate.

FIG. 13B shows X-ray absorption spectroscopy results showing the oxidation number of Ni and Mn transition metals that changes during a charge/discharge process of the electrochemical device according to Comparative Example 2.

Referring to FIG. 13B, at Pristine-Half charged, which is a Ni²⁺/Ni⁴⁺ reaction zone, it was confirmed that Ni was oxidized without any change in Mn, and thereafter, at the flat potential, which is an oxygen reaction zone, a change in the K-edge shape was observed due to a change in the adjacent local environment. In addition, it was confirmed that neither Ni nor Mn recovered to the initial state in the fully discharged state.

FIG. 13C shows X-ray absorption spectroscopy results showing the oxidation number of Ni and Mn transition metals that changes during a charge/discharge process of the electrochemical device according to Example.

Referring to FIG. 13C, it was confirmed that Example showed the same tendency as Comparative Examples, but when looking at the X-ray absorption spectroscopy graph of Mn in Example being closer to pristine than the X-ray absorption spectroscopy graph of Mn in Comparative Examples at Full discharged (fully-discharged state), it was confirmed that the Mn oxidation number of Example was less reduced than that of Comparative Examples. As a result, it can be inferred that the structure of Example was more suppressed from deterioration than that of Comparative Examples.

The features described in the above-described one embodiment may be combined with other embodiments, unless explicitly stated otherwise. In addition, although preferred embodiments of the present invention have been described in detail above, the scope of the present invention is not limited thereto, and various modifications and improvements by those skilled in the art using the basic concept of the present invention as defined in the following claims also fall within the scope of the present invention.

According to an aspect of the present disclosure, it is possible to implement a cathode active material in which primary particles and secondary particles grow evenly and have excellent particle shape uniformity, thereby improving non-reversibility during a charge/discharge process caused by instability of oxidized oxygen.

According to another aspect of the present disclosure, it is possible to implement a cathode active material capable of increasing a moving speed of lithium ions and increasing a charge/discharge rate of an electrochemical device.

According to another aspect of the present disclosure, it is possible to implement an electrochemical device having high charge capacity, discharge capacity, and coulombic efficiency.

In addition to the above-described effects, specific effects of the present invention will be described together while explaining the specific details for carrying out the invention below. In addition, effects of the present invention are not limited to the effects mentioned above, and may be easily implemented by means described herein and combinations thereof.

Although the CATHODE ACTIVE MATERIAL, MANUFACTURING METHOD CATHODE AND THEREOF, ELECTROCHEMICAL DEVICE have been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A cathode active material comprising an overlithiated layered oxide, wherein R calculated in Equation 1 below is 27 or less:
$$R = ( {P}_{A} / {P}_{B} ) \qquad [ Equation l ]$$
in accordance with Small-Angle X-ray Scattering (SAXS): wherein in Equation 1 above,
P_{A} is the volume (cm³/g) of macro pores included in the cathode active material, and
P_{B} is the volume (cm³/g) of micro pores included in the cathode active material,
wherein
the macro pores represent the sum of volume fractions (cm³g⁻¹/Å) corresponding to a pore radius of 10^{2.5} Å to 10^{3.5} Å, and
the micro pores represent the sum of volume fractions corresponding to a pore radius of about 10¹ Å to about 10^{2.5} Å.

2. The cathode active material of claim 1, wherein the cathode active material comprises a compound represented by General Formula 1 below: 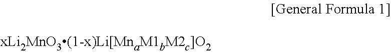
wherein in General Formula 1 above:
0<x<1 and a+b+c=1, wherein 0<a<1, 0≤b<1, and 0≤c<1, and M1 and M2 are transition metals different from each other, which is Ni or Co.

3. The cathode active material of claim 1, wherein the cathode active material comprises a compound represented by General Formula 2 below: 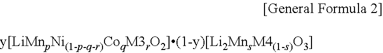
wherein in General Formula 2 above:
M3 and M4 are each independently one or more selected from the group consisting of Zr, Al, Re, V, Cr, Fe, Ga, Si, B, Ru, Ti, Nb, Mo, Mg, W, Na, and Pt, and 0.500<y<0.800, 0.450<p<0.650, 0≤q≤0.025, 0≤r≤0.100, and 0.900≤s≤1.000.

4. The cathode active material of claim 1, wherein in accordance with X-ray diffraction (XRD) analysis: a ratio I₍₀₀₃₎/I₍₁₀₄₎ of a diffraction X-ray intensity I₍₀₀₃₎ at a (003) peak to a diffraction X-ray intensity I₍₁₀₄₎ at a (104) peak is 1.31 or greater.

5. The cathode active material of claim 1, wherein in accordance with SAXS: the macro pores have a volume of 0.35 cm³/g to 0.45 cm³/g.

6. The cathode active material of claim 1, wherein in accordance with SAXS: the micro pores have a volume of 0.017 cm³/g to 0.025 cm³/g.

7. The cathode active material of claim 1, wherein in accordance with SAXS: the pores included in the cathode active material have a total pore volume of 0.475 cm³/g or less.

8. A method for manufacturing a cathode active material, the method comprising:
(S1) preparing a mixture including an overlithiated layered oxide precursor and a lithium precursor; and
(S2) heat-treating the mixture to manufacture a cathode active material, wherein in a manufacturing reaction of the cathode active material, the lithium precursor has a molar content lower than a stoichiometric molar content.

9. The method of claim 8, wherein the molar content of the lithium precursor is lower than the stoichiometric molar content by 0.5 mol % to 3 mol %.

10. The method of claim 8, wherein the step (S2) comprises heat-treating the mixture at 800° C. to 1100° C. for 0.5 hours to 15 hours under an atmospheric atmosphere.

11. A cathode active material manufactured by the method for manufacturing a cathode active material of claim 8.

12. A cathode comprising the cathode active material according to claim 1.

13. An electrochemical device comprising:
the cathode according to claim 12:
an anode;
a separator interposed between the cathode and the anode; and
an electrolyte.
